(19) United States
(12) Patent Application Publication
(10) Pub. No.: US 2010/0127159 A1
(43) Pub. Date: May 27, 2010

(54) PHOTODETECTING SEMICONDUCTOR APPARATUS AND MOBILE DEVICE

(76) Inventor: Nobuhisa WATANABE, Osaka (JP)

Correspondence Address: BIRCH STEWART KOLASCH & BIRCH, PO BOX 747, FALLS CHURCH, VA, 22040-0747, US

(21) Appl. No.: 12/571,797

(22) Filed: Oct. 1, 2009

(30) Foreign Application Priority Data
Nov. 25, 2008 (JP) 2008-299498

(51) Int. Cl. G01J 1/42

(52) U.S. Cl. 250/208.2

(57) ABSTRACT

One embodiment of a photodetecting semiconductor apparatus is provided with a sensor chip, a resin-sealed package in which the sensor chip is resin-sealed with a transparent resin, and a color filter disposed on the surface of the sensor chip, with a sensor circuit unit and a light-sensitive element group being formed in the sensor chip. The light-sensitive element group is configured with a color light-sensitive element having a sensitivity peak for color and an infrared light-sensitive element having a sensitivity peak for infrared light. The color light-sensitive element includes a red light-sensitive element having a sensitivity peak for red, a green light-sensitive element having a sensitivity peak for green, and a blue light-sensitive element having a sensitivity peak for blue.

### CROSS-REFERENCE TO RELATED APPLICATIONS

This application claims priority under 35 U.S.C. §119(a) on Patent Application No. 2008-299498 filed in Japan on Nov. 25, 2008, the entire contents of which are herein incorporated by reference.

### BACKGROUND OF THE INVENTION

1. Field of the Invention

The present invention relates to a photodetecting semiconductor apparatus provided with a color light-sensitive element and an infrared light-sensitive element as light-sensitive elements, and a mobile device equipped with the photodetecting semiconductor apparatus.

2. Description of the Related Art

Recently, mobile devices with a screen, typified by portable telephones and the like, have become widely used. Because improvement of portability is necessary, it is standard to use a liquid crystal panel having the characteristics of being light and thin for the screen of a mobile device. Also, increased convenience by prolonging battery life is sought in mobile devices. A battery can be made to have a long life by decreasing the power consumption of the liquid crystal panel by suppressing the brightness of a liquid crystal backlight when illuminance is low, such as at night, for example.

Against such a background, for example, in JP H9-146073A, it is proposed to mount an illuminance sensor for automatically adjusting screen brightness.

In this case, in order to perform display at brightness according to the surrounding illuminance, a small and inexpensive illuminance sensor that can be mounted in a mobile device is sought. Also, because the range of surrounding illuminance (dynamic range) is wide, a highly accurate illuminance sensor that has a wide illuminance detection range, and has wide dynamic range and high resolution, is sought.

Also, for example in a portable telephone, a screen with a touch panel function is adopted, and thus an input human interface is improved. However, in a portable telephone with a touch panel function, there is a risk that the touch panel function will detect human skin during a telephone call, so that the touch panel function operates erroneously. Accordingly, a detection sensor is sought that detects human skin (mainly the cheeks) as a detected item. For the function of detecting a detected item, it is possible to apply an optical sensor, and for example, an optical object detection sensor is proposed in JP H3-39640A.

A conventional photodetecting semiconductor apparatus (illuminance sensor) is described with reference to FIGS. 8A to 8C.

FIGS. 8A to 8C are schematic diagrams that show the general structure of a photodetecting semiconductor apparatus according to a conventional example, where FIG. 8A is a cross-sectional view, FIG. 8B is a plan view, and FIG. 8C is a plan view of a sensor chip.

The conventional photodetecting semiconductor apparatus is provided with a mounting substrate 110, a sensor chip 111 mounted on the mounting substrate 110, a glass cover 119 that covers and protects the sensor chip 111, a light-emitting element 116, and a lens 118 disposed corresponding to the light-emitting element 116, as well as a light-blocking wall 115 that holds the glass cover 119 and the lens 118, and blocks external light.

A color filter 111f is disposed on the surface of the sensor chip 111. Also, a glass filter 119f that cuts infrared light is applied to the glass cover 119. There are problems such as that size reduction is difficult due to the use of the glass cover 119 and the glass filter 119f, and strength is reduced when the size is reduced.

The color filter 111f is disposed corresponding to an unshown light-sensitive element on the surface of the sensor chip 111. The color filter 111f is divided into an area R that corresponds to the color red, an area G that corresponds to the color green, and an area B that corresponds to the color blue. Also, a sensor circuit unit 111c is formed in the chip 111.

By using the sensor circuit unit 111c to perform calculation processing of a light sensing current detected by the light-sensitive element, the function (illuminance detection) as a photodetecting semiconductor apparatus is realized. With the conventional sensor circuit unit 111c, the dynamic range when measuring illuminance is constant, and gain of an amplifier including the sensor circuit unit 111c is not changed.

Accordingly, when increasing the illuminance measurement resolution, there is no other method than increasing the resolution of an analog/digital conversion unit including the sensor circuit unit 111c. However, when the resolution of the analog/digital conversion unit is increased, the circuit scale of the analog/digital conversion unit becomes large, and as a result the sensor circuit unit 111c becomes large, so there is the problem that increasing the resolution of the analog/digital conversion unit leads to increased package size and increased cost.

### SUMMARY OF THE INVENTION

The present invention was made in view of such circumstances, and it is an object thereof to provide a small photodetecting semiconductor apparatus that is provided with, as light-sensitive elements, a color light-sensitive element that has a sensitivity peak for color and an infrared light-sensitive element that has a sensitivity peak for infrared light, and due to being provided with a calculation unit that performs calculation processing of a light sensing signal output of the light-sensitive elements, has both an illuminance detection function that is applicable to a wide illuminance range (dynamic range) and a proximity detection function whereby it is possible to detect a nearby detected item, the photodetecting semiconductor apparatus being applicable to a small mobile device.

It is another object of the invention to provide a highly convenient mobile device that is provided with an illuminance detection function and a proximity detection function, due to mounting the photodetecting semiconductor apparatus according to the invention.

The photodetecting semiconductor apparatus according to the present invention is provided with a light-sensitive element group configured with a plurality of types of light-sensitive elements that convert light to current, and a light-emitting element that emits infrared light, and executes detection of a detected item and detection of surrounding illuminance, the photodetecting semiconductor apparatus having: a voltage conversion unit that stores a charge of the light sensing current detected by the light-sensitive element and converts the stored charge to a light sensing voltage; a shutter unit that is connected between the light-sensitive element and the voltage conversion unit, and selects whether or not to store the charge of the light sensing current detected by the light-sensitive element; an amplification unit that is connected to the voltage conversion unit and amplifies the light sensing voltage converted by the voltage conversion unit and outputs a light sensing amplified voltage; an analog/digital conversion unit that converts the light sensing amplified voltage output by the amplification unit to a digital value; and a calculation unit that performs calculation processing to change the digital value converted by the analog/digital conversion unit to light sensing signal output by the light-sensitive element; wherein the light-sensitive element group includes, as the light-sensitive element, a color light-sensitive element having a sensitivity peak for color and an infrared light-sensitive element having a sensitivity peak for infrared light, and detects surrounding illuminance by calculating the light sensing signal output based on the light sensing current detected by the color light-sensitive element and the infrared light-sensitive element, and detects a detected item based on the light sensing current difference between the light sensing current in the infrared light-sensitive element due to infrared light reflected from the detected item when the light-emitting element has been caused to emit light and the light sensing current in the infrared light-sensitive element due to surrounding illuminance.

With this configuration, it is possible to achieve reduced size, and possible to insure a dynamic range necessary for highly accurate illuminance detection, so it is possible to provide a small photodetecting semiconductor apparatus that is capable of detection of surrounding illuminance and detection of a detected item without reducing illuminance detection accuracy and resolution.

Also, in the photodetecting semiconductor apparatus according to the present invention, a configuration is adopted in which the color light-sensitive element includes a red light-sensitive element having a sensitivity peak for red, a green light-sensitive element having a sensitivity peak for green, and a blue light-sensitive element having a sensitivity peak for blue, and the calculation unit calculates surrounding illuminance Y as Y=αR+βG+γB+εIr (where R, G, B, and Ir respectively are the light sensing signal output of the red light-sensitive element, the green light-sensitive element, the blue light-sensitive element, and the infrared light-sensitive element, and α, β, γ, and ε respectively are correction coefficients for R, G, B, and Ir).

With this configuration, it is possible to detect surrounding illuminance with high accuracy by calculating surrounding illuminance in correspondence with a spectral sensitivity that has been adapted to luminosity.

Also, in the photodetecting semiconductor apparatus according to the present invention, a configuration is adopted in which the color light-sensitive element includes a green light-sensitive element having a sensitivity peak for green, and the calculation unit calculates surrounding illuminance Y as Y=βG+εIr (where G and Ir respectively are the light sensing signal output of the green light-sensitive element and the infrared light-sensitive element, and B and c respectively are correction coefficients for G and Ir).

With this configuration, because the light-sensitive element group is simplified, it is possible to reduce size by reducing the area of the light-sensitive element group and the sensor circuit unit, and thus the photodetecting semiconductor apparatus can be small and inexpensive.

Also, in the photodetecting semiconductor apparatus according to the present invention, a configuration is adopted in which an open time of the shutter unit is changed according to the detected surrounding illuminance.

With this configuration, by controlling the charge storage time, it is possible to insure the dynamic range of illuminance detection in a state in which illuminance detection accuracy and resolution are maintained, and thus possible to detect the surrounding illuminance with high accuracy regardless of the state of the surrounding illuminance.

Also, in the photodetecting semiconductor apparatus according to the present invention, a configuration is adopted in which the shutter unit is configured with a MOS element.

With this configuration, it is possible to control the open time of the shutter unit easily and with high accuracy.

Also, in the photodetecting semiconductor apparatus according to the present invention, a configuration is adopted in which the light-sensitive element group is resin-sealed in a resin-sealed package.

With this configuration, it is possible to eliminate the glass filter and adopt a resin-sealed package in the photodetecting semiconductor apparatus, and thus the size of the photodetecting semiconductor apparatus can be reduced.

Also, in the photodetecting semiconductor apparatus according to the present invention, a configuration is adopted in which detection of a detected item is performed by converting the light sensing current difference between the light sensing current in the infrared light-sensitive element due to infrared light reflected from the detected item when the light-emitting element has been caused to emit light and the light sensing current in the infrared light-sensitive element due to surrounding illuminance to a light sensing voltage with the voltage conversion unit, and comparing the converted light sensing voltage to a proximity threshold voltage that has been set in advance.

With this configuration, it is possible to eliminate the effect of surrounding illuminance, so that the detected item is detected based only on the light sensing signal due to reflected light from the detected item, and thus it is possible to detect the distance to the detected item easily and with high accuracy.

Also, a mobile device according to the present invention is provided with a display screen and a photodetecting semiconductor apparatus, and the photodetecting semiconductor apparatus is the photodetecting semiconductor apparatus according to the present invention.

With this configuration, it is possible to provide a convenient mobile device in which it is possible to adjust the brightness of the display screen according to the surrounding illuminance, and in which it is possible to prolong battery life by suppressing the power necessary for display by the display screen.

Also, according to the mobile device according to the present invention, because the mobile device is provided with a display screen and a photodetecting semiconductor apparatus, and the photodetecting semiconductor apparatus is the photodetecting semiconductor apparatus according to the present invention, an effect is exhibited that it is possible to provide a convenient mobile device in which it is possible to adjust the brightness of the display screen according to the surrounding illuminance, and in which it is possible to prolong battery life by suppressing the power necessary for display by the display screen.

### BRIEF DESCRIPTION OF THE DRAWINGS

FIGS. 1A to 1C are schematic diagrams that show the general structure of a photodetecting semiconductor apparatus according to Embodiment 1 of the present invention, where FIG. 1A is a cross-sectional view, FIG. 1B is a plan view, and FIG. 1C is a plan view of a sensor chip.

FIGS. 2A and 2B are block diagrams that show an overview of equivalent circuits of a sensor circuit unit that includes the sensor chip of the photodetecting semiconductor apparatus according to Embodiment 1 of the present invention, where FIG. 2A shows the configuration of an entire circuit from light-emitting and light-sensitive elements to output, and FIG. 2B shows the configuration of an adjacent circuit that takes out a light sensing current of a light-sensitive element.

FIG. 3 is a timing chart that illustrates operation states of the equivalent circuits of the photodetecting semiconductor apparatus according to Embodiment 1 of the present invention.

FIG. 4 is a spectral sensitivity graph that shows spectral sensitivity, a luminosity curve, and a calculated spectral curve for each light-sensitive element of the photodetecting semiconductor apparatus according to Embodiment 1 of the present invention.

FIG. 5 is a flowchart that shows a process of adjusting the dynamic range in an illuminance detection mode of the photodetecting semiconductor apparatus according to Embodiment 1 of the present invention.

FIG. 6 is a plan view of a sensor chip of a photodetecting semiconductor apparatus according to Embodiment 2 of the present invention.

FIG. 7 is a spectral sensitivity graph that shows spectral sensitivity, a luminosity curve, and a calculated spectral curve for each light-sensitive element of the photodetecting semiconductor apparatus according to Embodiment 2 of the present invention.

FIGS. 8A to 8C are schematic diagrams that show the general structure of a photodetecting semiconductor apparatus according to a conventional example, where FIG. 8A is a cross-sectional view, FIG. 8B is a plan view, and FIG. 8C is a plan view of a sensor chip.

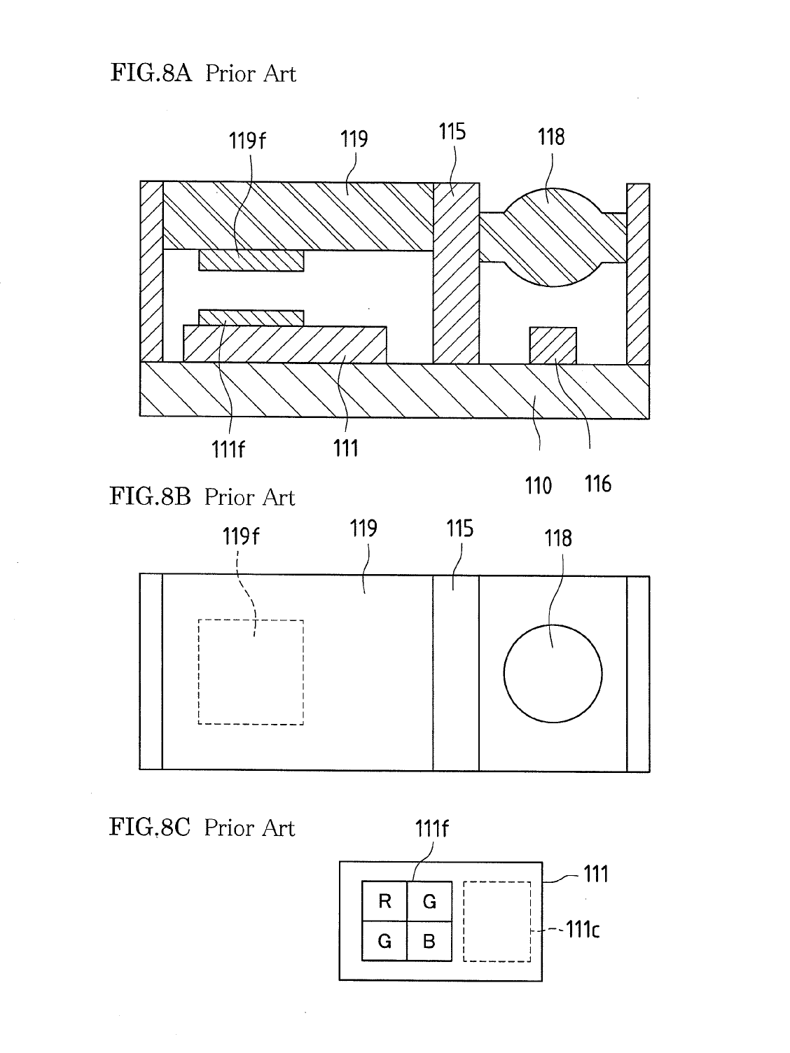

### DESCRIPTION OF THE PREFERRED EMBODIMENTS

Hereinafter, embodiments of the present invention will be described with reference to the drawings.

### Embodiment 1

A photodetecting semiconductor apparatus according to Embodiment 1 will be described with reference to the drawings.

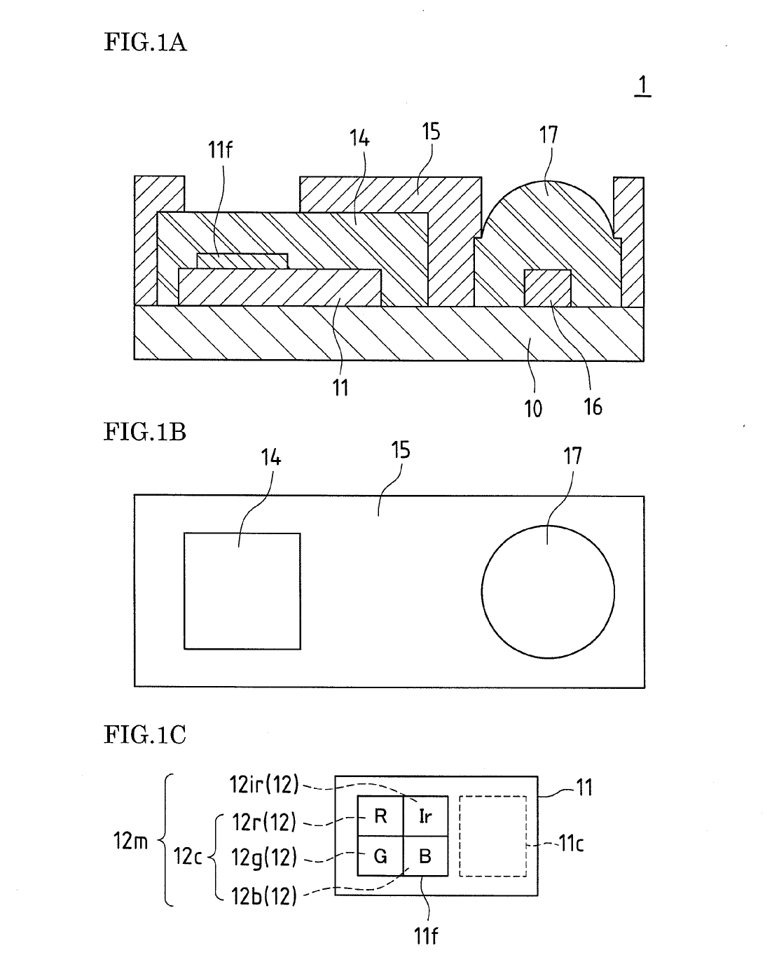

FIGS. 1A to 1C are schematic diagrams that show the general structure of a photodetecting semiconductor apparatus according to Embodiment 1 of the present invention, where FIG. 1A is a cross-sectional view, FIG. 1B is a plan view, and FIG. 1C is a plan view of a sensor chip.

This photodetecting semiconductor apparatus 1 according to the present embodiment is provided with a mounting substrate 10 of ceramic or the like, a sensor chip 11 mounted to the mounting substrate 10, a resin-sealed package 14 in which the sensor chip 11 is resin-sealed with a transparent resin, a light-blocking resin unit 15 that covers the area surrounding the resin-sealed package 14 and prevents incidence of unnecessary external light, and a color filter 11f disposed on the surface of the sensor chip 11.

The sensor chip 11 is configured with a so-called CMOS image sensor (Complementary MOS image sensor), and therefore is provided with a light sensitive element 12 (light-sensitive element group 12m) and a sensor circuit unit 11c.

Also, the photodetecting semiconductor apparatus 1 is provided with a light-emitting element 16 that is mounted to the mounting substrate 10 and emits infrared light, and a light-emitting resin-sealed unit 17 that covers the light-emitting element 16. The light-emitting element 16 is configured with a so-called LED (Light-Emitting Diode).

The sensor circuit unit 11c and the light-sensitive element group 12m are formed in the sensor chip 11. The light-sensitive element group 12m is configured with a color light-sensitive element 12c that has a sensitivity peak for color and an infrared light-sensitive element 12ir that has a sensitivity peak for infrared light.

By providing the light-emitting element 16 that emits infrared light and the infrared light-sensitive element 12ir, it is possible to emit infrared light to illuminate a detected item, and detect reflected light from the detected item. That is, it is possible to detect whether or not the detected item is present (distance to the detected item). Also, it is possible to detect surrounding illuminance with the color light-sensitive element 12c.

Also, the configuration of the color light-sensitive element 12c includes a red light-sensitive element 12r that has a sensitivity peak for red, a green light-sensitive element 12g that has a sensitivity peak for green, and a blue light-sensitive element 12b that has a sensitivity peak for blue.

The color filter 11f is disposed to the color light-sensitive element 12c (the red light-sensitive element 12r, the green light-sensitive element 12g, and the blue light-sensitive element 12b). The color filter 11f is divided into an area R corresponding to the color red, an area G corresponding to the color green, an area B corresponding to the color blue, and also an area Ir corresponding to infrared light.

The color light-sensitive element 12c and the infrared light-sensitive element 12ir sense light via the color filter 11f, and therefore can have respective sensitivity peaks.

When it is not particularly necessary to individually describe the color light-sensitive element 12c (the red light-sensitive element 12r, the green light-sensitive element 12g, and the blue light-sensitive element 12b) and the infrared light-sensitive element 12ir, they may be described as simply the light-sensitive element 12.

As described above, the light-sensitive element group 12m is resin-sealed in the resin-sealed package 14. Accordingly, it is possible for the photodetecting semiconductor apparatus 1 to have reduced size with a glass filter eliminated.

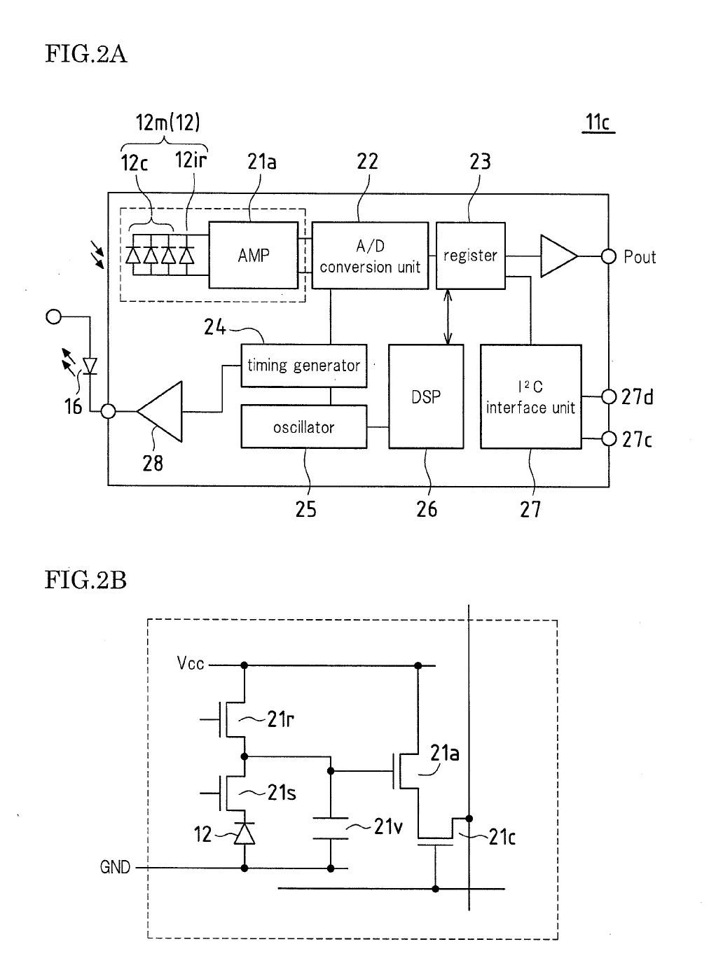

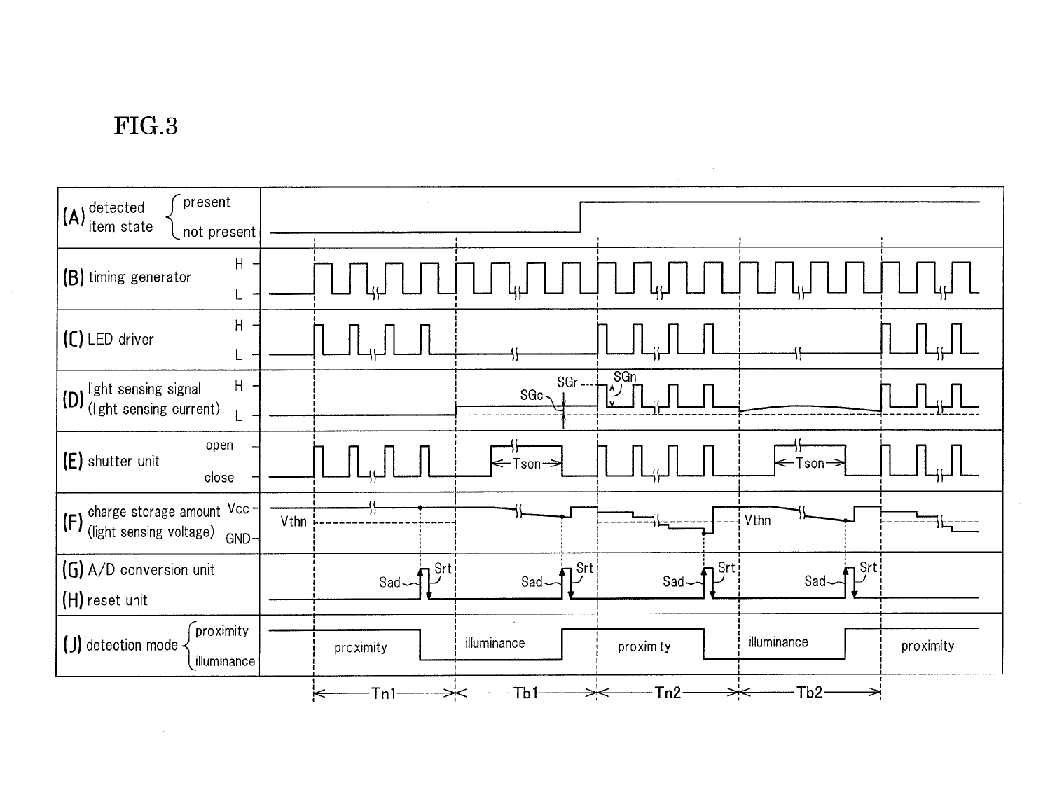

FIGS. 2A and 2B are block diagrams that show an overview of equivalent circuits of a sensor circuit unit that includes the sensor chip of the photodetecting semiconductor apparatus according to Embodiment 1 of the present invention, where FIG. 2A shows the configuration of an entire circuit from light-emitting and light-sensitive elements to output, and FIG. 2B shows the configuration of an adjacent circuit that takes out a light sensing current of a light-sensitive element. Detailed operation states will be described with reference to the timing chart in FIG. 3.

The sensor circuit unit 11c (photodetecting semiconductor apparatus 1) according to the present embodiment is provided with a voltage conversion unit 21v that stores the charge of a light sensing current detected by the light-sensitive element 12 and converts that stored charge to a light sensing voltage, a shutter unit 21s that is connected between the light-sensitive element 12 and the voltage conversion unit 21v and selects whether or not to store the charge of the light sensing current detected by the light-sensitive element 12, an amplification unit 21a that is connected to the voltage conversion unit 21v and amplifies the light sensing voltage converted by the voltage conversion unit 21v and outputs a light sensing amplified voltage, an analog/digital conversion unit 22 (A/D conversion unit) that converts the light sensing amplified voltage output by the amplification unit 21a to a digital value, and a calculation unit that performs calculation processing to change the digital value converted by the analog/digital conversion unit 22 to light sensing signal output by the light-sensitive element 12.

The charge from the light-sensitive element 12 is stored in the voltage conversion unit 21v during a period in which the shutter unit 21s is in an open state (on state).

The calculation unit is specifically configured with a DSP (Digital Signal Processor) 26. Therefore, according to a program that has been incorporated in advance, it is possible to perform calculation processing on a light sensing signal based on the light sensing current detected by the light-sensitive element 12. The sensor circuit unit 11c is provided with a register 23 and an I²C interface unit 27 that operate in coordination with the DSP 26. Operation of the DSP 26, the register 23, and the I²C interface unit 27 themselves is ordinarily known technology, so a detailed description of that operation is omitted.

Output from the register 23 includes signals and ‘L’ signals from an output terminal Pout, so that it is possible to output presence information of a detected item. Also, the I²C interface unit 27 is provided with a serial clock terminal 27c and a serial data terminal 27d, and is configured to perform processing smoothly in coordination with an external unit. A detected surrounding illuminance can be output from the serial data terminal 27d.

Also provided are an oscillator 25 that forms a clock pulse necessary for digital signal processing, a timing generator 24 that generates a timing signal based on the clock pulse formed by the oscillator 25, and an LED driver 28 that controls light emission of the light-emitting element 16 based on the pulse from the timing generator 24.

Also, the sensor circuit unit 11c is further provided with an output selection unit 21c that switches the amplification unit 21a to make it possible to read out the output (light sensing amplified voltage) of the amplification unit 21a with the analog/digital conversion unit 22, and a charge reset unit 21r that resets the charge stored in the voltage conversion unit 21v. By setting the charge reset unit 21r to an on state, initialization of the voltage conversion unit 21v is executed. The voltage conversion unit 21v is configured with a capacitor, and is capable of accurately converting a stored charge amount to a light sensing voltage.

The sensor chip 11 is configured with a CMOS image sensor, and so the shutter unit 21s, the voltage conversion unit 21v, the amplification unit 21a, the output selection unit 21c, and the charge reset unit 21r are configured with MOS (Metal Oxide Semiconductor) elements. Due to configuration with MOS elements, it is possible to control an open time Tson (see FIG. 3) of the shutter unit 21s easily and with high accuracy.

Control of the shutter unit 21s, the charge reset unit 21r, and the output selection unit 21c can be executed by applying an appropriate control pulse corresponding to the program incorporated in the DSP 26.

FIG. 3 is a timing chart that illustrates operation states of the equivalent circuits of the photodetecting semiconductor apparatus according to Embodiment 1 of the present invention.

The photodetecting semiconductor apparatus 1 is provided with, as detection modes (sensing functions), a proximity detection mode (proximity detection function) that detects a detected item, and an illuminance detection mode (illuminance detection function) that detects surrounding illuminance. As for switching of the proximity detection mode and the illuminance detection mode, a time-sharing configuration is adopted in which the modes are switched with each other at a period that has been set in advance.

In the proximity detection mode, the light-emitting element 16 is caused to emit light, reflected light from the detected item is detected with the light-sensitive element 12 (the infrared light-sensitive element 12ir), and presence of the detected item can be detected by whether or not a proximity threshold Vthn set in advance is surpassed.

In the illuminance detection mode, a charge is stored in the voltage conversion unit 21v (capacitor) that converts the light sensing current from the surrounding light to a light sensing voltage, and by detecting the stored charge amount (light sensing voltage), it is possible to detect the surrounding luminance.

FIG. 3 shows waveforms of respective states, divided into (A) detected item state, (B) timing generator, (C) LED driver, (D) light sensing signal (light sensing current), (E) shutter unit, (F) charge storage amount (light sensing voltage), (G) A/D conversion unit, (H) charge reset unit, and (J) detection mode. Operation states are described below.

In (B) timing generator, a basic clock pulse that advances the timing chart is generated at appropriate periods, and operation of each unit is controlled according to the period of the basic clock pulse to synchronize with the period of the basic clock pulse.

In (J) detection mode, the ‘proximity detection mode’ and the ‘illuminance detection mode’ are switched at an appropriate period that has been set in advance. A proximity corresponding period Tn1 corresponds to the proximity detection mode, an illuminance corresponding period Tb1 corresponds to the illuminance detection mode, a proximity corresponding period Tn2 corresponds to the proximity detection mode, and an illuminance corresponding period Tb2 corresponds to the illuminance detection mode. The effect of the clock pulse of the timing generator 24 produces a border area of one pulse, and stabilizes switching of the proximity detection mode and the illuminance detection mode.

In (A) detected item state, a state ‘present’ or ‘not present’ is indicated. In the proximity corresponding period Tn1 and the illuminance corresponding period Tb1, a state in which the detected item is not present is indicated. In the proximity corresponding period Tn2 and the illuminance corresponding period Tb2, a state in which the detected item is present is indicated.

When the detected item is detected in the proximity detection mode, as indicated by (C) LED driver, a drive pulse is applied from the LED driver 28 to the light-emitting element 16, and so infrared light is emitted from the light-emitting element 16. In the proximity detection mode, as indicated by (E) shutter unit, the shutter unit 21s is opened/closed in synchronization with driving of the light-emitting element 16. That is, the shutter unit 21s is set to an open state so that a charge is stored by the voltage conversion unit 21v only in a period in which the light-emitting element 16 emits light, thus suppressing the incidence of unnecessary external light.

In the proximity corresponding period Tn1, because the detected item is not present, as indicated by (D) light sensing signal (light sensing current), the light sensing current from the light-sensitive element 12 is not generated, so detection information is not produced. However, in the proximity corresponding period Tn2, the detected item is present, so as indicated by (D) light sensing signal (light sensing current), a light sensing signal (light sensing current) is generated.

Detection of the detected item in the proximity detection mode can be performed according to the light sensing signal (light sensing current) indicated by (D) light sensing signal (light sensing current). For example, in the proximity corresponding period Tn2, the infrared light-sensitive element 12ir can detect reflected light (infrared light) from the detected item as a light sensing signal SGr. On the other hand, the infrared light-sensitive element 12ir detects both reflected light and incident light from surrounding illuminance (surrounding brightness).

Accordingly, the reference position of the light sensing signal is a surrounding illuminance signal SGc. By using the difference of the light sensing signal SGr and the surrounding illuminance signal SGc (i.e., light sensing current difference) as a detection target (proximity light sensing signal SGn), the effect of surrounding illuminance is eliminated, so that it is possible to detect the detected item based only on the light sensing signal due to reflected light from the detected item, and thus it is possible to detect the distance to the detected item easily and with high accuracy.

As described above, a charge is stored in the voltage conversion unit 21v corresponding to the proximity light sensing signal SGn (light sensing current: proximity light sensing current), and can be detected as (F) charge storage amount (light sensing voltage). As indicated by (F) charge storage amount (light sensing voltage), for storage of a charge according to the proximity light sensing signal SGn, a plurality of pulses are summed, and by discriminating by comparing this sum to the proximity threshold voltage Vthn that has been set in advance, it is possible to detect whether or not the detected item is present.

That is, the present embodiment is configured such that the detected item is detected based on a light sensing current difference between the light sensing current in the infrared light-sensitive element 12ir due to infrared light reflected from the detected item when the light-emitting element 16 has been caused to emit light and the light sensing current in the infrared light-sensitive element 12ir due to surrounding illuminance.

More specifically, detection of the detected item is executed by using the voltage conversion unit 21v to convert the light sensing current difference between the light sensing current in the infrared light-sensitive element 12ir due to infrared light reflected from the detected item when the light-emitting element 16 has been caused to emit light and the light sensing current in the infrared light-sensitive element 12ir due to surrounding illuminance to a light sensing voltage, and comparing that converted voltage to the proximity threshold voltage Vthn that has been set in advance.

Accordingly, it is possible to eliminate the effect of surrounding illuminance, so that the detected item is detected based only on the light sensing signal due to reflected light from the detected item, and thus it is possible to detect the distance to the detected item easily and with high accuracy.

As indicated by (G) A/D conversion unit, the output selection unit 21c is set to an on state according to a signal Sad synchronized with ending of the proximity detection mode, so the charge storage amount (charging voltage of the voltage conversion unit 21v) indicated by (F) charge storage amount (light sensing voltage) is input to the analog/digital conversion unit 22 via the amplification unit 21a and A/D-converted.

Immediately after processing according to the signal Sad has finished, the charge reset unit 21r is set to an on state according to a signal Srt, so the voltage conversion unit 21v is initialized. In this embodiment, for example, initialization is performed by setting the (F) charge storage amount (light sensing voltage) to a power supply voltage Vcc.

As described above, the amplification unit 21a amplifies the light sensing voltage converted by the voltage conversion unit 21v to a light sensing amplified voltage. That is, a light sensing amplified voltage that corresponds to the charge storage amount (light sensing current) is input to the analog/digital conversion unit 22.

For the sake of convenience of description, the proximity threshold voltage Vthn was described together with the waveform of (F) charge storage amount (light sensing voltage), but the proximity threshold voltage Vthn is converted to a digital value and stored in the register 23 in advance.

Because the digital value that has been A/D-converted by the analog/digital conversion unit 22 is stored in the register 23, the light sensing voltage (digital value) and the proximity threshold voltage Vthn (digital value) are compared by the register 23, the results of comparison are output from the output terminal Pout as an ‘H’ signal or an ‘L’ signal, and thus it is possible to output presence information of the detected item.

Also, because the present embodiment is configured such that light sensing current flows from the light-sensitive element 12 to a GND (a ground potential), in the waveform indicated by (F) charge storage amount (light sensing voltage), a charge is stored in the direction that the potential decreases. However, by changing the circuit configuration, it is possible to adopt a configuration in which a charge is stored in the direction that the potential increases.

When detecting the surrounding illuminance in the illuminance detection mode, the light-emitting element 16 is put in a non-light-emitting state ((C) LED driver). On the other hand, the shutter unit 21s is put in an open state (on state), and during the open time Tson, the light sensing current detected by the light-sensitive element 12 (the color light-sensitive element 12c and the infrared light-sensitive element 12ir) is stored as a charge as indicated by (F) charge storage amount (light sensing voltage). Also, as described above, due to the circuit configuration, the charge storage amount is stored in the direction that potential decreases.

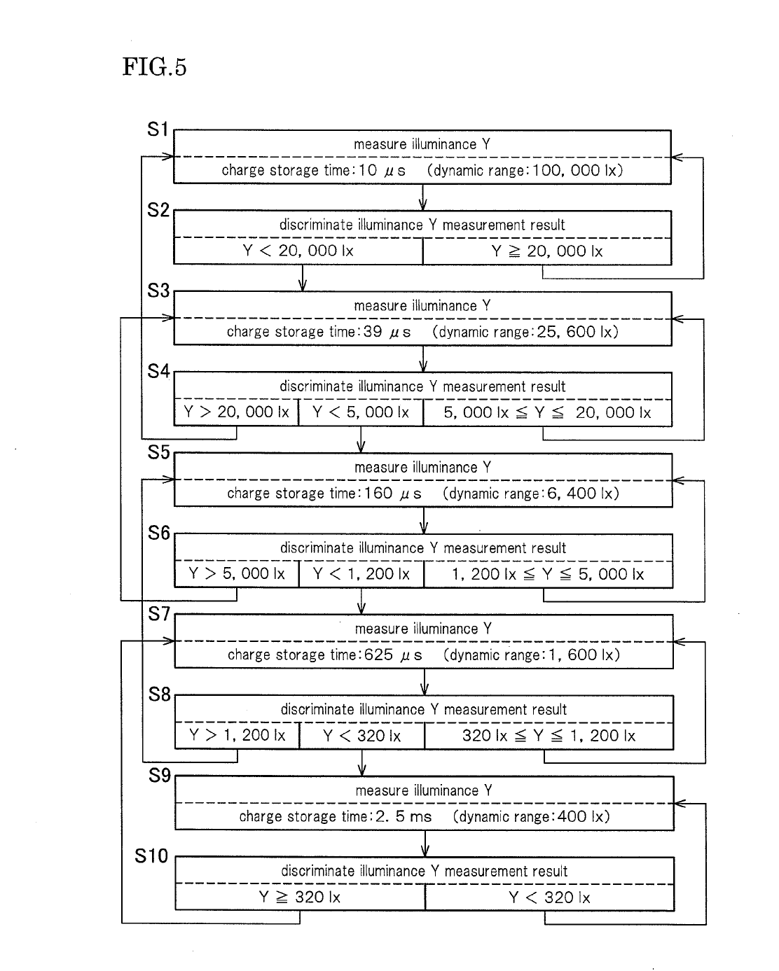

The open time Tson (charge storage time) of the shutter unit 21s can be appropriately adjusted according to the surrounding illuminance (further illustrated in FIG. 5).

When the illuminance detection mode is ended, the output selection unit 21c is set to the on state according to the signal Sad synchronized with ending of the illuminance detection mode. Accordingly, the charge storage amount (charging voltage of the voltage conversion unit 21v: light sensing voltage) indicated by (F) charge storage amount (light sensing voltage) is input to the analog/digital conversion unit 22 via the amplification unit 21a and A/D-converted.

As in the case of the proximity detection mode, in the illuminance detection mode as well, immediately after processing is ended by the signal Sad, the charge reset unit 21r is set to the on state according to the signal Srt, so it is possible to initialize the voltage conversion unit 21v. In the present embodiment, as described above, initialization is performed by setting the (F) charge storage amount (light sensing voltage) to the power source voltage Vcc.

As described above, the amplification unit 21a amplifies the light sensing voltage converted by the voltage conversion unit 21v to a light sensing amplified voltage. That is, a light sensing amplified voltage that corresponds to the charge storage amount (light sensing current) is input to the analog/digital conversion unit 22. The charge storage amount (i.e. the light sensing amplified voltage) here is a value corresponding to the surrounding luminance. The analog/digital conversion unit 22 converts the light sensing amplified voltage output by the amplification unit 21 to a digital value, and stores the converted digital value in the register 23 as the light sensing signal output (digital value) from the light-sensitive element 12.

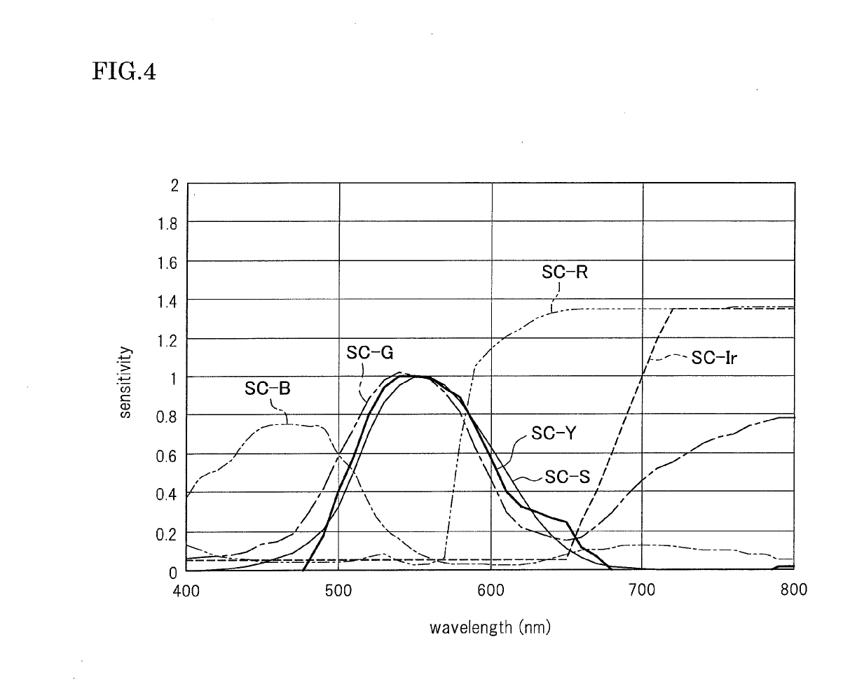

The light sensing signal output converted to a digital value and stored in the register 23 by the analog/digital conversion unit 22 is supplied to the DSP 26 serving as a calculation unit, where according to a program incorporated in advance, appropriate calculation processing is performed on the supplied value. That is, the DSP 26 calculates the light sensing signal output based on the light sensing current detected by the light-sensitive element 12 (the color light-sensitive element 12c and the infrared light-sensitive element 12ir), and thus the surrounding illuminance is detected. Calculation by the DSP 26 will be further described with reference to FIG. 4.

As described above, the photodetecting semiconductor apparatus 1 according to the present embodiment is provided with the light-sensitive element group 12m configured with the plurality of types of light-sensitive elements 12 that convert light to current, and the light-emitting element 16 that emits infrared light, and executes detection of a detected item and detection of surrounding illuminance, the photodetecting semiconductor apparatus 1 being provided with: the voltage conversion unit 21v that stores a charge of the light sensing current detected by the light-sensitive element 12 and converts the stored charge to a light sensing voltage; the shutter unit 21s that is connected between the light-sensitive element 12 and the voltage conversion unit 21v, and selects whether or not to store the charge of the light sensing current detected by the light-sensitive element 12; the amplification unit 21a that is connected to the voltage conversion unit 21v and amplifies the light sensing voltage converted by the voltage conversion unit 21v and outputs a light sensing amplified voltage; the analog/digital conversion unit 22 that converts the light sensing amplified voltage output by the amplification unit 21a to a digital value; and the calculation unit (DSP 26) that performs calculation processing to change the digital value converted by the analog/digital conversion unit 22 to light sensing signal output by the light-sensitive element 12. The light-sensitive element group 12m includes, as the light-sensitive element 12, the color light-sensitive element 12c having a sensitivity peak for color and the infrared light-sensitive element 12ir having a sensitivity peak for infrared light; and detects surrounding illuminance by calculating the light sensing signal output based on the light sensing current detected by the color light-sensitive element 12c and the infrared light-sensitive element 12ir; and detects a detected item based on the light sensing current difference between the light sensing current in the infrared light-sensitive element 12ir due to infrared light reflected from the detected item when the light-emitting element 16 has been caused to emit light and the light sensing current in the infrared light-sensitive element 12ir due to surrounding illuminance.

Accordingly, because an infrared ray-cutting glass filter is made unnecessary and so a resin sealed package (the resin-sealed package 14) can be adopted, reduced size can be achieved, the charge storage time can be controlled by the shutter unit 21s, dynamic range in illuminance detection can be insured, and so it is possible to configure the photodetecting semiconductor apparatus 1 such that the surrounding illuminance and the detected item can be detected without reducing the illuminance detection accuracy and resolution.

FIG. 4 is a spectral sensitivity graph that shows spectral sensitivity, a luminosity curve, and a calculated spectral curve for each light-sensitive element of the photodetecting semiconductor apparatus according to Embodiment 1 of the present invention.

Wavelength (nm) is shown on the horizontal axis, and sensitivity (relative sensitivity) is shown on the vertical axis.

As shown in FIG. 4, the spectral sensitivity (relative value of the light sensing signal output to the wavelength) respectively differs for each light-sensitive element 12. That is, the spectral sensitivity of the red light-sensitive element 12r having a sensitivity peak for red is indicated by a red element spectral curve SC-R, the spectral sensitivity of the green light-sensitive element 12g having a sensitivity peak for green is indicated by a green element spectral curve SC-G, the spectral sensitivity of the blue light-sensitive element 12b having a sensitivity peak for blue is indicated by a blue element spectral curve SC-B, and the spectral sensitivity of the infrared light-sensitive element 12ir having a sensitivity peak for infrared light is indicated by an infrared element spectral curve SC-Ir.

Luminosity relative to spectral sensitivity of the light-sensitive element 12 is indicated by a luminosity curve SC-S. For measurement of illuminance (surrounding illuminance), the light-sensitive element 12 is required to have a spectral sensitivity that coincides with luminosity (the luminosity curve SC-S).

The spectral sensitivity of the light-sensitive element 12 is measured in a state in which the color filter 12 (area R corresponding to red, area G corresponding to green, area B corresponding to blue, and area Ir corresponding to infrared light; FIG. 1(B)) has been applied.

For example, the green element spectral curve SC-G has characteristics comparatively close to the luminosity curve SC-S. Accordingly, it is also conceivable to apply the green color filter that is applied to the green element spectral curve SC-G, but the green color filter is displaced relative to the luminosity curve SC-S, so application of the green color filter as-is inadequate from the viewpoint of accuracy.

That is, calculation processing is necessary in which, using the output (light sensing signal output to be processed by the DSP 26 used as the calculation unit) of the light-sensitive element 12 (the red light-sensitive element 12r, the green light-sensitive element 12g, the blue light-sensitive element 12b, and the infrared light-sensitive element 12ir), the output (light sensing signal output) of the light-sensitive element group 12m as a whole is conformed to the luminosity curve SC-S.

In the present embodiment, by performing calculation of surrounding illuminance Y=+0.1R+1.0G−0.3B−0.6Ir (where R, G, B, and Ir are light sensing signal outputs that respectively correspond to the red light-sensitive element 12r, the green light-sensitive element 12g, the blue light-sensitive element 12b, and the infrared light-sensitive element 12ir), output (light sensing signal output) that conforms to luminosity can be obtained. That is, the surrounding illuminance Y has the spectral characteristics indicated by the calculated spectral curve SC-Y, and thus it is possible to approximate the luminosity curve SC-S with high accuracy.

As for the spectral curve for each light-sensitive element 12 shown in FIG. 4, although only one example, the calculation formula surrounding illuminance Y=+0.1R+1.0G−0.3B−0.6Ir can be generalized, and can be expressed as surrounding illuminance Y=αR+βG+γB+εIr (where α, β, γ, and ε respectively are correction coefficients for R, G, B, and Ir). The correction coefficients (α, β, γ, and ε) at this time can be obtained by performing simulation using a computer. Also, this calculation formula can be incorporated as a program in advance in the DSP 26, and can be executed in appropriate coordination with the register 23 and the I²C interface unit 27.

That is, the calculation unit (DSP 26) according to the present embodiment is configured to calculate (detect) the surrounding illuminance Y as Y=αR+βG+γB+εIr (where R, G, B, and Ir respectively are the light sensing signal output of the red light-sensitive element 12r, the green light-sensitive element 12g, the blue light-sensitive element 12b, and the infrared light-sensitive element 12ir, and α, β, γ, and ε respectively are correction coefficients for R, G, B, and Ir).

With this configuration, it is possible to detect surrounding illuminance with high accuracy by calculating surrounding illuminance in correspondence with a spectral sensitivity that has been adapted to luminosity.

The difference in sensitivity may also be the difference for the light-sensitive element 12. Accordingly, by reducing the light sensing area to reduce the output for a light-sensitive element 12 that has high sensitivity, for example, it is possible to arrange the sensitivity relative to the other light-sensitive elements 12. That is, by adjusting the light sensing area of the light-sensitive element 12 not according to the above calculation formula, it is possible for the light-sensitive element 12 to have characteristics near the luminosity curve SC-S, so the calculation in the calculation unit (DSP 26) can be simplified.

FIG. 5 is a flowchart that shows a process of adjusting the dynamic range in an illuminance detection mode of the photodetecting semiconductor apparatus according to Embodiment 1 of the present invention.

In the photodetecting semiconductor apparatus 1 according to the present embodiment, in the illuminance detection mode, the shutter unit 21s is put in an open state (on state) during the period of the open time Tson, so that the light sensing current detected by the light-sensitive element 12 (the color light-sensitive element 12c and the infrared light-sensitive element 12ir) is stored as a charge and converted to a light sensing voltage. That is, the open time Tson is also a charge storage time.

Accordingly, by controlling opening/closing of the shutter unit 21s to change the open time Tson, the charge storage time can be changed. That is, the dynamic range for illuminance when measuring illuminance can be changed by controlling the open time Tson, and thus it is possible to insure an optimal dynamic range in a state in which illuminance detection accuracy and resolution are kept at a high level.

In a case where the sensitivity of the light-sensitive element 12 (sensor circuit unit 11c) is, for example, 3V/(lx·s), when illuminance is 100,000 lx, the charge storage amount can be set to 3V with charge storage time=10 μs. If illuminance is 10 lx, then charge storage time=100 ms is necessary.

Conventionally, in order to insure adequate dynamic range, a high resolution A/D converter having, for example, 16 bit resolution (resolution with 65,536 levels) was adopted as the analog/digital conversion unit 22. However, in the present embodiment, it is possible to change the dynamic range by controlling the open time Tson of the shutter unit 21s, so it is not necessary to adopt a high resolution A/D converter as in the conventional technology.

In below Steps S1 to S10, a processing flow is indicated in which the dynamic range is changed to maintain highly accurate resolution.

Step S1:

Illuminance Y (surrounding illuminance) is measured beginning with the highest dynamic range. For example, it is possible to store 3V, which corresponds to sensitivity for dynamic range=100,000 lx, charge storage time=10 μs. Accordingly, it is possible to measure the illuminance Y by detecting the light sensing voltage (light sensing amplified voltage) when the charge storage time is set to 10 μs.

Step S2:

The illuminance Y measured in Step S1 is discriminated. Because this is the highest dynamic range, for example, the illuminance Y is discriminated in two divisions: Y<20,000 lx and Y≧20,000 lx.

When Y<20,000 lx, because the illuminance Y is small, processing proceeds to Step S3 in which processing is performed for a small dynamic range, and the dynamic range is switched to a small dynamic range. When Y≧20,000 lx, because the illuminance Y is large, processing returns to Step S1, where illuminance is measured.

Step S3:

Illuminance Y (surrounding illuminance) is measured. For example, it is possible to store 3V, which corresponds to sensitivity for dynamic range=25,600 lx, charge storage time=39 μs.

Step S4:

The illuminance Y measured in Step S3 is discriminated. For example, the illuminance Y is discriminated in three divisions: Y>20,000 lx, Y<5,000 lx, and 5,000 lx≦Y≦20,000 lx.

When Y>20,000 lx, because the illuminance Y is large, processing returns to Step S1, and the dynamic range is increased. When Y<5,000 lx, because the illuminance Y is small, processing proceeds to Step S5, where the dynamic range is switched. When 5,000 lx≦Y≦20,000 lx, processing returns to Step S3 and the dynamic range is maintained.

Step S5:

Illuminance Y (surrounding illuminance) is measured. For example, it is possible to store 3V, which corresponds to sensitivity for dynamic range=6,400 lx, charge storage time=160 μs.

Step S6:

The illuminance Y measured in Step S5 is discriminated. For example, the illuminance Y is discriminated in three divisions: Y>5,000 lx, Y<1,200 lx, and 1,200 lx≦Y≦5,000 lx.

When Y>5,000 lx, processing returns to Step S3. When Y<1,200 lx, processing proceeds to Step S7. When 1,200 lx≦Y≦5,000 lx, processing returns to Step S5.

Step S7:

Illuminance Y (surrounding illuminance) is measured. For example, it is possible to store 3V, which corresponds to sensitivity for dynamic range=1,600 lx, charge storage time=625 μs.

Step S8:

The illuminance Y measured in Step S7 is discriminated. For example, the illuminance Y is discriminated in three divisions: Y>1,200 lx, Y<320 lx, and 320 lx≦Y≦1,200 lx.

When Y>1,200 lx, processing returns to Step S5. When Y<320 lx, processing proceeds to Step S9. When 320 lx≦Y≦1,200 lx, processing returns to Step S7.

Step S9:

Illuminance Y (surrounding illuminance) is measured. For example, it is possible to store 3V, which corresponds to sensitivity for dynamic range=400 lx, charge storage time=2.5 ms.

Step S10:

The illuminance Y measured in Step S7 is discriminated. Because this is the lowest dynamic range, for example, the illuminance Y is discriminated in two divisions: Y≧320 lx and Y<320 lx.

When Y≧320 lx, processing returns to Step S7. When Y<320 lx, processing returns to Step S9.

As described above, by changing the charge storage time (the open time Tson of the shutter unit 21s) according to the processing flow in Steps S1 to S10, it is possible to switch the dynamic range easily and with high accuracy in a state in which high resolution is maintained.

With a conventional illuminance sensor, in order to make the dynamic range variable it is necessary to change amplifier gain, so there is the problem that the circuit configuration becomes complicated.

However, according to the present embodiment, it is possible to switch the dynamic range by only switching the open time Tson of the shutter unit 21s, and it is not necessary to increase the resolution of the analog/digital conversion unit 22, so a simple circuit configuration can be maintained. Thus, it is possible to provide the small and inexpensive photodetecting semiconductor apparatus 1 capable of measuring illuminance with high accuracy.

As described above, in the present embodiment, a configuration is adopted in which the open time Tson of the shutter unit 21s is changed according to the detected surrounding illuminance. Accordingly, by controlling the charge storage time, it is possible to insure the dynamic range of illuminance detection in a state in which illuminance detection accuracy and resolution are maintained, and thus possible to detect the surrounding illuminance with high accuracy regardless of the state of the surrounding illuminance.

### Embodiment 2

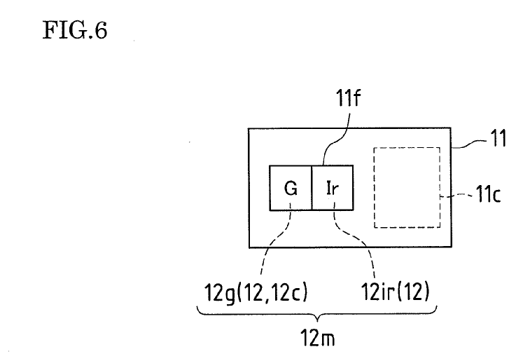

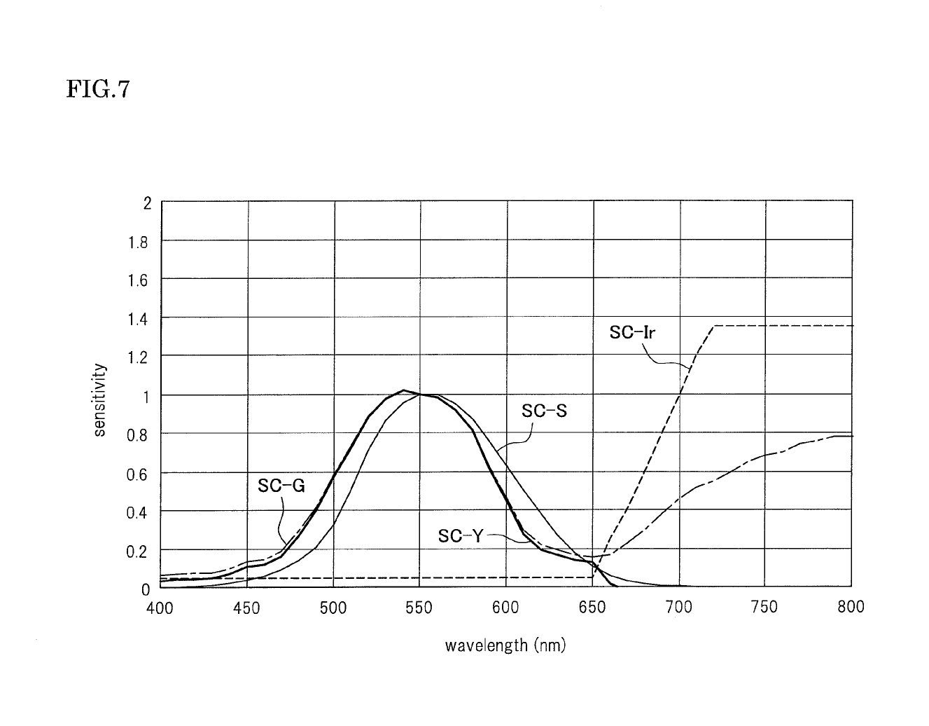

A photodetecting semiconductor apparatus according to the present embodiment will be described based on FIGS. 6 and 7.

The photodetecting semiconductor apparatus according to the present embodiment has basically the same configuration as the photodetecting semiconductor apparatus 1 according to Embodiment 1, mainly differing items will be described, with the aid of reference symbols.

FIG. 6 is a plan view of a sensor chip of the photodetecting semiconductor apparatus according to Embodiment 2 of the present invention.

The photodetecting semiconductor apparatus 1 according to Embodiment 1 is provided with the color light-sensitive element 12c and the infrared light-sensitive element 12ir as the light-sensitive element 12 (the light-sensitive element group 12m), and is provided with the red light-sensitive element 12r, the green light-sensitive element 12g, and the blue light-sensitive element 12b as the color light-sensitive element 12c.

On the other hand, in the present embodiment, as in Embodiment 1, the color light-sensitive element 12c and the infrared light-sensitive element 12ir are provided as the light-sensitive element 12 (the light-sensitive element group 12m). However, only the green light-sensitive element 12g is provided as the color light-sensitive element 12c. That is, the configuration of the light-sensitive element 12 (the light-sensitive element group 12m) is simplified, so further reduced size and cost can be achieved in comparison to the photodetecting semiconductor apparatus 1 according to Embodiment 1.

FIG. 7 is a spectral sensitivity graph that shows spectral sensitivity, a luminosity curve, and a calculated spectral curve for each light-sensitive element of the photodetecting semiconductor apparatus according to Embodiment 2 of the present invention.

Wavelength (nm) is shown on the horizontal axis, and sensitivity (relative sensitivity) is shown on the vertical axis. The basic configuration is the same as in FIG. 4.

As described above, only the two light sensitive elements, the green light-sensitive element 12g and the infrared light-sensitive element 12ir, are provided as the light-sensitive element 12. That is, the color light-sensitive element 12c includes the green light-sensitive element 12g that has a sensitivity peak for green.

Accordingly, the spectral sensitivity of the green light-sensitive element 12g having a sensitivity peak for green is indicated by the green element spectral curve SC-G, and the spectral sensitivity of the infrared light-sensitive element 12ir having a sensitivity peak for infrared light is indicated by an infrared element spectral curve SC-Ir. Also, luminosity relative to spectral sensitivity of the light-sensitive element 12 is indicated by the luminosity curve SC-S.

Also, same as in Embodiment 1, the sensor circuit 11c is provided, and calculation processing is performed by the calculation unit (DSP 26). In Embodiment 1, surrounding illuminance Y=αR+βG+γB+εIr is stipulated as the calculation formula, but in the present embodiment, the light-sensitive element 12 is limited to the green light-sensitive element 12g and the infrared light-sensitive element 12ir, so the calculation formula can be simplified.

That is, the calculation unit (DSP 26) calculates the surrounding illuminance Y as Y=βG+εIr (where G and Ir respectively are the light sensing signal output of the green light-sensitive element 12g and the infrared light-sensitive element 12ir, and β and ε respectively are correction coefficients for G and Ir).

The result obtained as surrounding illuminance Y=αR+βG+γB+εIr according to the present embodiment yields the spectral characteristics indicated by the calculated spectral curve SC-Y, and successfully approximate the luminosity curve SC-S.

Accordingly, because the light-sensitive element group 12m is simplified, it is possible to reduce size by reducing the area of the light-sensitive element group 12m and the sensor circuit unit 11c, and thus the photodetecting semiconductor apparatus 1 can be small and inexpensive.

### Embodiment 3

A mobile device (not shown) according to the present embodiment is, for example, a portable telephone or the like, and is provided with a display screen and a battery. The mobile device is used in various illuminance environments, such as indoors and outdoors, so achievement of lower power consumption by performing display with the brightness of the display screen adapted to the surrounding illuminance environment is sought.

The photodetecting semiconductor apparatus 1 according to Embodiment 1 or 2 is applied (mounted) to the mobile device according to the present embodiment, so this mobile device can detect surrounding illuminance easily and with high accuracy, and can also detect a detected item.

Accordingly, it is possible to provide a convenient mobile device in which it is possible to adjust the brightness of the display screen according to the surrounding illuminance, and in which it is possible to prolong battery life by suppressing the power necessary for display by the display screen.

Also, when the mobile device is provided with a touch panel, it is possible to apply a proximity detection mode to detect a detected item, so it is possible to detect a human body (for example, skin such as that of the cheek). Accordingly, it is possible to prevent, for example, erroneous operation due to the touch panel contacting the human body during a telephone call by the portable telephone.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. A photodetecting semiconductor apparatus that is provided with a light-sensitive element group configured with a plurality of types of light-sensitive elements that convert light to current, and a light-emitting element that emits infrared light, and executes detection of a detected item and detection of surrounding illuminance, the photodetecting semiconductor apparatus comprising:
a voltage conversion unit that stores a charge of the light sensing current detected by the light-sensitive element and converts the stored charge to a light sensing voltage;
a shutter unit that is connected between the light-sensitive element and the voltage conversion unit, and selects whether or not to store the charge of the light sensing current detected by the light-sensitive element;
an amplification unit that is connected to the voltage conversion unit and amplifies the light sensing voltage converted by the voltage conversion unit and outputs a light sensing amplified voltage;
an analog/digital conversion unit that converts the light sensing amplified voltage output by the amplification unit to a digital value;
and a calculation unit that performs calculation processing to change the digital value converted by the analog/digital conversion unit to light sensing signal output by the light-sensitive element;
wherein the light-sensitive element group includes, as the light-sensitive element, a color light-sensitive element having a sensitivity peak for color and an infrared light-sensitive element having a sensitivity peak for infrared light; and
detects surrounding illuminance by calculating the light sensing signal output based on the light sensing current detected by the color light-sensitive element and the infrared light-sensitive element; and
detects a detected item based on the light sensing current difference between the light sensing current in the infrared light-sensitive element due to infrared light reflected from the detected item when the light-emitting element has been caused to emit light and the light sensing current in the infrared light-sensitive element due to surrounding illuminance.

2. The photodetecting semiconductor apparatus according to claim 1,
wherein the color light-sensitive element includes a red light-sensitive element having a sensitivity peak for red, a green light-sensitive element having a sensitivity peak for green, and a blue light-sensitive element having a sensitivity peak for blue, and
the calculation unit calculates surrounding illuminance Y as Y=αR+βG+γB+εIr (where R, G, B, and Ir respectively are the light sensing signal output of the red light-sensitive element, the green light-sensitive element, the blue light-sensitive element, and the infrared light-sensitive element, and α, β, γ, and ε respectively are correction coefficients for R, G, B, and Ir).

3. The photodetecting semiconductor apparatus according to claim 1,
wherein the color light-sensitive element includes a green light-sensitive element having a sensitivity peak for green, and
the calculation unit calculates surrounding illuminance Y as Y=βG+εIr (where G and Ir respectively are the light sensing signal output of the green light-sensitive element and the infrared light-sensitive element, and β and ε respectively are correction coefficients for G and Ir).

4. The photodetecting semiconductor apparatus according to claim 1, wherein an open time of the shutter unit is changed according to the detected surrounding illuminance.

5. The photodetecting semiconductor apparatus according to claim 4, wherein the shutter unit is configured with a MOS element.

6. The photodetecting semiconductor apparatus according to claim 1, wherein the light-sensitive element group is resin-sealed in a resin-sealed package.

7. The photodetecting semiconductor apparatus according to claim 1, wherein detection of a detected item is performed by converting the light sensing current difference between the light sensing current in the infrared light-sensitive element due to infrared light reflected from the detected item when the light-emitting element has been caused to emit light and the light sensing current in the infrared light-sensitive element due to surrounding illuminance to a light sensing voltage with the voltage conversion unit, and comparing the converted light sensing voltage to a proximity threshold voltage that has been set in advance.

8. A mobile device comprising a display screen and a photodetecting semiconductor apparatus,
wherein the photodetecting semiconductor apparatus is the photodetecting semiconductor apparatus according to claim 1.

9. The photodetecting semiconductor apparatus according to claim 2, wherein the light-sensitive element group is resin-sealed in a resin-sealed package.

10. The photodetecting semiconductor apparatus according to claim 3, wherein the light-sensitive element group is resin-sealed in a resin-sealed package.

11. The photodetecting semiconductor apparatus according to claim 4, wherein the light-sensitive element group is resin-sealed in a resin-sealed package.

12. The photodetecting semiconductor apparatus according to claim 5, wherein the light-sensitive element group is resin-sealed in a resin-sealed package.

13. The photodetecting semiconductor apparatus according to claim 2, wherein detection of a detected item is performed by converting the light sensing current difference between the light sensing current in the infrared light-sensitive element due to infrared light reflected from the detected item when the light-emitting element has been caused to emit light and the light sensing current in the infrared light-sensitive element due to surrounding illuminance to a light sensing voltage with the voltage conversion unit, and comparing the converted light sensing voltage to a proximity threshold voltage that has been set in advance.

14. The photodetecting semiconductor apparatus according to claim 3, wherein detection of a detected item is performed by converting the light sensing current difference between the light sensing current in the infrared light-sensitive element due to infrared light reflected from the detected item when the light-emitting element has been caused to emit light and the light sensing current in the infrared light-sensitive element due to surrounding illuminance to a light sensing voltage with the voltage conversion unit, and comparing the converted light sensing voltage to a proximity threshold voltage that has been set in advance.

15. The photodetecting semiconductor apparatus according to claim 4, wherein detection of a detected item is performed by converting the light sensing current difference between the light sensing current in the infrared light-sensitive element due to infrared light reflected from the detected item when the light-emitting element has been caused to emit light and the light sensing current in the infrared light-sensitive element due to surrounding illuminance to a light sensing voltage with the voltage conversion unit, and comparing the converted light sensing voltage to a proximity threshold voltage that has been set in advance.

16. The photodetecting semiconductor apparatus according to claim 5, wherein detection of a detected item is performed by converting the light sensing current difference between the light sensing current in the infrared light-sensitive element due to infrared light reflected from the detected item when the light-emitting element has been caused to emit light and the light sensing current in the infrared light-sensitive element due to surrounding illuminance to a light sensing voltage with the voltage conversion unit, and comparing the converted light sensing voltage to a proximity threshold voltage that has been set in advance.

17. The photodetecting semiconductor apparatus according to claim 6, wherein detection of a detected item is performed by converting the light sensing current difference between the light sensing current in the infrared light-sensitive element due to infrared light reflected from the detected item when the light-emitting element has been caused to emit light and the light sensing current in the infrared light-sensitive element due to surrounding illuminance to a light sensing voltage with the voltage conversion unit, and comparing the converted light sensing voltage to a proximity threshold voltage that has been set in advance.

18. A mobile device comprising a display screen and a photodetecting semiconductor apparatus,
wherein the photodetecting semiconductor apparatus is the photodetecting semiconductor apparatus according to claim 2.

19. A mobile device comprising a display screen and a photodetecting semiconductor apparatus,
wherein the photodetecting semiconductor apparatus is the photodetecting semiconductor apparatus according to claim 3.

20. A mobile device comprising a display screen and a photodetecting semiconductor apparatus,
wherein the photodetecting semiconductor apparatus is the photodetecting semiconductor apparatus according to claim 4.
